(19) United States
(12) Patent Application Publication
(10) Pub. No.: US 2026/0265547 A1
(43) Pub. Date: Sep. 10, 2026

(54) COMPOSITIONS AND METHODS FOR PROTECTING A SURFACE

(71) Applicant: Energizer Auto, Inc., St. Louis, MO (US)

(72) Inventor: Sarah Springer, Westlake, OH (US)

(73) Assignee: Energizer Auto, Inc., St. Louis, MO (US)

(21) Appl. No.: 19/556,874

(22) Filed: Mar. 4, 2026

Related U.S. Application Data
(60) Provisional application No. 63/766,757, filed on Mar. 4, 2025.

(51) Int. Cl. C09D 7/20; B05D 1/02; B05D 5/06; C09D 7/43; C09D 7/63; C09D 7/80; C09D 183/06; C09D 191/06

(52) U.S. Cl. CPC C09D 7/20; B05D 1/02; B05D 5/06; C09D 7/43; C09D 7/63; C09D 7/80; C09D 183/06; C09D 191/06; B05D 2518/12

(57) ABSTRACT

The present disclosure describes compositions including water, one or more wax emulsions, and one or more film formers; and optionally one or more wetting agents, one or more silicone emulsions, one or more rheology modifiers, one or more preservatives, one or more dyes, and/or a fragrance. The present disclosure also describes methods of preparing compositions. Additionally, the present disclosure describes methods of protecting an exterior surface or an interior surface including applying a composition of the present disclosure to the surface and allowing the composition to form a protective film on the surface.

### CROSS-REFERENCE TO RELATED APPLICATIONS

This application claims the benefit of U.S. Provisional Application No. 63/766,757, filed Mar. 4, 2025, which is incorporated herein by reference in its entirety.

### FIELD OF THE DISCLOSURE

The present disclosure relates to compositions and methods for protecting surfaces. More particularly, the compositions of the present disclosure may provide long lasting protection, superior durability, and shine to the surface, and may be disposed in a convenient trigger spray dispenser.

### BACKGROUND OF THE DISCLOSURE

Vehicle surfaces are exposed to many harsh conditions during normal use: weather such as rain sun, hail, and wind; road conditions such as salt and rocks; environmental debris such as dirt, dust, sand, sticks, leaves, pinecones, tree sap, bird droppings, and bugs; and vehicle conditions such as oil, grease, and old or damaged windshield wipers. Many of these conditions cause and/or contribute to the accumulation of damage to the surface in the form of contaminants and scratches. Contaminants and scratches present maintenance and durability concerns because contaminants can deteriorate the surface, and the contaminants and scratches can contribute to the development of larger scratches, the further accumulation of contaminants, and the further deterioration, oxidation, and fading of the surface from environmental factors such as ultraviolet (UV) radiation. Additionally, contaminants and scratches contribute to a negative aesthetic appearance of a surface, and of a vehicle as a whole. Despite these problems, contaminants and small scratches often do not justify the replacement or re-painting of a surface, which are both very costly to consumers. Therefore, there is a need to protect their vehicle's exterior surfaces by creating a protective barrier against contaminants, scratches, and environmental elements.

Consumers often turn to surface wax products which can provide a protective coating for vehicle surfaces, repel contaminants, protect against environmental damage, preserve the vehicles appearance, and make it easier to clean the surface of contaminants. Wax products can also enhance a vehicle's gloss and shine to improve its appearance. While such compositions for protecting surfaces are available, these formulas/products often have a short lifespan and low durability, requiring frequent reapplication, are difficult to apply evenly and without streaks, contain low-quality ingredients that do not provide sufficient protection against scratches, and low-quality waxes may also contain abrasives that can damage the surfaces if not used correctly. Because of such deficiencies, there is a need for improved compositions and methods for protecting surfaces.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The compositions described herein can include a solvent, one or more wax emulsions, and one or more film formers. The compositions can optionally include one or more wetting agents, one or more silicone emulsions, one or more rheology modifiers, one or more preservatives, one or more dyes, and/or a fragrance. In embodiments, the compositions can include, water, an anionic paraffin wax emulsion, an anionic carnauba wax emulsion, and one or more silicone-based polymers, and optionally one or more cellulose-based polymers, one or more C12-C14 secondary alcohol ethoxylates, an amino-functionalized silicone emulsion, a preservative including benzisothiazolinone (BIT), and optionally wherein the preservative includes BIT, methylisothiazolinone (MIT), and methylchloroisothiazolinone (CMIT), water soluble yellow colorant, and/or fragrance with pineapple whip aroma.

The present disclosure describes methods of preparing the compositions presented herein. In embodiments, the methods can include adding water to a container; under constant mixing, adding in one or more film formers and mixing; and adding in one or more wax emulsions while mixing to obtain the composition. The methods described herein can optionally include adding in one or more silicone emulsions, one or more wetting agents, one or more rheology modifiers, one or more preservatives, a fragrance, or one or more dyes.

The present disclosure describes methods of protecting an exterior surface or an interior surface of a vehicle, wherein the method can include applying a composition of the present disclosure to the surface and allowing the composition to form a protective film on the surface. In embodiments, the protective film is formed within 15 seconds to 2 mins. In some cases, the composition is sprayed on the surface or wiped onto the surface using an applicator. The composition can then be buffed to form a streak-free film. In embodiments, the surface can include metal, paint, plastic, rubber, as well as premium finishes, for example carbon fiber, vinyl wraps, decals and glossy, matte, and satin paint finishes. In embodiments, the surface can include the surface of a vehicle.

### BRIEF DESCRIPTION OF THE DRAWINGS

FIG. 1 shows performance testing results of a composition of the present disclosure on a painted surface.

FIG. 2 shows contact angle measurements of a surface before (initial) and after application of Example Composition 4 (Ex. Comp. 4), as well as measurements taken over 12 car washes to determine durability of the composition.

FIG. 3 shows color depth measurements (L Value) of a surface before (initial) and after application of Example Composition 4 (Ex. Comp. 4), as well as measurements taken over 12 car washes to determine durability of the composition.

FIG. 4 shows gloss/shine measurements (20 Gloss) of a surface before (initial) and after application of Example Composition 4 (Ex. Comp. 4), as well as measurements taken over 12 car washes to determine durability of the composition.

FIG. 5 shows that compositions of the present disclosure (Ex. Comp. 4) can be used on matte surfaces without significantly increasing shine.

FIG. 6 shows that compositions of the present disclosure can enhances color and shine. The image shows a car hood split in half (dashed line) where the right half is treated with Example Composition 4 (Ex. Comp. 4) & the left half is untreated.

FIG. 7 shows comparative testing of hydrophobicity, color depth, shine, durability, and hydrophobicity after 12 washes for Example Composition 4 and two competitive products (Comparative Example 1 and Comparative Example 2). Hydrophobicity, color depth, and shine values are taken immediately after application. Durability compares hydrophobicity and color depth changes over 12 car washes.

FIG. 8 shows comparative testing of hydrophobicity over 12 car washes for Example Composition 4 and two competitive products (Comparative Example 1 and Comparative Example 2).

FIG. 9 shows comparative testing of color depth over 12 car washes for Example Composition 4 and two competitive products (Comparative Example 1 and Comparative Example 2).

FIG. 10 shows comparative testing of hydrophobicity, color depth, and shine for Example Composition 5 and two competitive products (Comparative Example 3 and Comparative Example 4).

FIG. 11 shows comparative testing of hydrophobicity, color depth, and shine for Example Composition 5 and two competitive products (Comparative Example 5 and Comparative Example 6).

### DETAILED DESCRIPTION

The present disclosure describes compositions and methods for protecting a surface, for example an exterior surface or an interior surface of a vehicle. In embodiments, the present disclosure describes compositions including various components, such as a solvent, one or more wax emulsions, and one or more film formers; and optionally one or more wetting agents, one or more silicone emulsions, one or more rheology modifiers, one or more preservatives, one or more dyes, and/or a fragrance. The present disclosure also describes methods of preparing compositions described herein. Additionally, the present disclosure describes methods of protecting an exterior surface or an interior surface including applying a composition of the present disclosure to the surface and allowing the composition to form a protective film on the surface.

In embodiments, the exterior surface or the interior surface can include a metal surface, a painted surface, a plastic surface, a rubber surface, or a glass surface. In some cases, compositions described herein can be used on premium finishes, for example carbon fiber, vinyl wraps, decals, and glossy, matte, and satin paint finishes. In embodiments, the exterior surface can include the exterior surface of a vehicle and the interior surface can include the interior surface of a vehicle. The term vehicle includes any means of carrying or transporting, such as a car, a truck, a trailer, an RV, a bus, a train, an airplane, a boat, a ship, a spaceship, construction equipment, farming equipment, a cart, a motorcycle, a side car, and a bicycle. Examples of the exterior of a surface of a vehicle include a metal surface of a vehicle such as the surface of a wheel, trim, or chrome, a painted surface of a vehicle such as the body of the vehicle, the hood, the roof, or the doors, a plastic surface of a vehicle such as trim, bumpers, headlights, or brake lights, a rubber surface of a vehicle such as tires, or a glass surface of a vehicle such as the windshield, windows, mirrors, or sun/moon roofs. In embodiments, the exterior surface can include an exterior surface that is not related to a vehicle.

The compositions and methods of the present disclosure satisfy the consumer need for durable, long lasting, premium compositions and user-friendly methods to apply a layer of wax protection to exterior surfaces or interior surfaces. In embodiments, compositions of the present disclosure provide a premium product with enhanced benefits compared to surface protection compositions on the market. In embodiments, compositions and methods described herein provide a superior protective coating for surfaces that repels contaminants and protects against environmental damage, preserves the appearance of surfaces, and makes it easier to clean the surface of contaminants. Compositions and methods described herein also provide improved durability, enhanced gloss, color depth, water repellency, and shine to improve the appearance of a surface, and simple application. Compositions of the present disclosure include a hybrid ceramic formulation. The term “hybrid ceramic” refers to the combination of silicone with waxes. For example, waxes can include synthetic and/or natural waxes, such as paraffin and/or carnauba waxes. In embodiments, the hybrid ceramic compositions described herein can protect and improve shine and color depth of a surface, for example, for 12 months or more. For example, the compositions can protect against harmful UVA and UVB rays and prevent surface oxidation.

UV damage or oxidation from sunlight can cause fading, and dullness of exterior automotive surfaces. Degradation of the clear coat can cause rust and other issues to the metal of the car. Given the costly investment that vehicles are and the cost to repair paint or remove rust, it is very important to protect and extend the longevity of the exterior.

The compositions of the present disclosure contain silicone-based polymers (resins) and natural and synthetic waxes that help reflect UV-rays to assist in minimizing UV-oxidation that can naturally occur over time with UV exposure. In some cases, compositions described herein contain a blend of trimethylsiloxysilicate (a high molecular weight, film-forming silicone resin) and cyclopentasiloxane, for example DOWSIL RSN0749 (decamethylcyclopentasiloxane and trimethylsiloxysilicate), MOMENTIVE SS4230 silicone resin (cyclopentasiloxane and trimethylsiloxysilicate), and CQsil Q5 LK-Q5 (cyclopentasiloxane and trimethylsiloxysilicate). Historically, the term “ceramics” or “ceramic films” can be defined as silicone-based film forming agents. SiOx is a material that protects from photo-oxidation that can cause UV induced degradation of surfaces.

Carnauba wax, extracted from the leaves of a Brazilian palm, contains many different functional groups. Contained in carnauba wax is a complex mixture of esters, free alcohols, aliphatic acids, aromatic acids, free w-hydrocarboxylic aids, hydrocarbons, and triterpene diols, with esters being 80% of the mixture. Within this mixture is p-methoxycinnamic diesters that have been found to have high UV absorption and thermal stability. Carnauba wax and synthetic waxes can also provide UV protection to automotive paint. Paraffin wax is also a UV-inhibitor that can be used in formulation to protect pain from UV-oxidation caused by sunlight.

The compositions and methods described herein can provide superior shine and protection to a surface. The compositions can cure immediately, for example within 15 seconds to 2 minutes, once sprayed onto a surface and leaves a protective barrier that preserves and enhances the surface while shielding the surface from contamination and environmental/chemical sources such as surface oxidation, harmful UV rays, stains, and etching from acid rain. In embodiments, a protective film is formed within 15 seconds to 2 mins of applying a composition of the present disclosure to a surface. The compositions of the present disclosure provide durable lasting protection, and superior performance in accelerated weather/UV testing, robust exterior surface durability and safety testing, colorimeter testing, contact angle testing, and surface tension and resistance testing. The compositions of the present disclosure also provide improved water beading (hydrophobicity), high shine finish, and improved color depth. Moreover, the compositions of the present disclosure provide improved and pleasing aroma, including a pineapple scent. The compositions may be dispensed from a trigger/spray bottle which provides a fine mist and even application of the composition to a surface. In embodiments, compositions may be applied to wet or dry surfaces. The compositions described herein minimize streaking and buffing time when applied to surfaces.

The compositions of the present disclosure can include a solvent, one or more wax emulsions, and one or more film formers. In some cases, the one or more wax emulsions can include one or more paraffin wax emulsions and/or one or more carnauba wax emulsions. In embodiments, the compositions optionally can include two or more wetting agents, one or more silicone emulsions, one or more rheology modifiers, one or more preservatives, one or more dyes, and/or a fragrance.

The solvent can include clean purified water, such as distilled water, demineralized water, deionized water (DI), or reverse osmosis (R/O) water. In embodiments, compositions of the present disclosure can include by total weight of the composition about 80.00% to 98.00% water, about 80.00% to 95.00% water, 85.00% to 93.00% water, about 88.521% water, about 87.650%, or about 92.141% water.

The one or more wetting agents can be chosen based on a desired hydrophilic-lipophilic balance (HLB) of the composition. The HLB value of the one or more wetting agents in the composition is about 7-15, 7-13, 8-13, 7-9, 11-13, 11-15, 8, 9, 10, 11, 12, 13, 14, or 15. The one or more wetting agents having the desired HLB can include one or more alcohol ethoxylates, for example one or more C12-C14 secondary alcohol ethoxylates. In embodiments, compositions of the present disclosure can include by total weight of the composition about 0.50% to 3.00% of two C12-C14 secondary alcohol ethoxylates, about 0.990% of two C12-C14 secondary alcohol ethoxylates, or about 1.500% of two C12-C14 secondary alcohol ethoxylates. For example, about 0.45% to 2.00% of a first C12-C14 secondary alcohol ethoxylate and about 0.05% to 1.0% of a second C12-C14 secondary alcohol ethoxylate, about 0.690% of a first C12-C14 secondary alcohol ethoxylate and about 0.300% of a second C12-C14 secondary alcohol ethoxylate, or about 1.000% of a first C12-C14 secondary alcohol ethoxylate and about 0.500% of a second C12-C14 secondary alcohol ethoxylate. Examples of wetting agents of the present disclosure include TERGITOL 15-S-7 and TERGITOL 15-S-3. Both TERGITOL 15-S-7 and TERGITOL 15-S-3 include C12-C14 secondary alcohol ethoxylates. TERGITOL 15-S-7 has a HLB of 12.1 and ethylene oxides (EO) of 7. TERGITOL 15-S-3 has a HLB of 8 and EO of 3. In embodiments, a wetting agent inducing C9-11 alcohol ethoxylates may be used, for example BEROL 260 (C9-11 Alcohol ethoxylate) and BEROL 266 (C9-11 Alcohol ethoxylate).

The one or more paraffin wax emulsions can include an anionic and/or nonionic paraffin wax emulsion. In embodiments, compositions of the present disclosure can include by total weight of the composition about 0.50% to 3.00% of one or more paraffin wax emulsions, 1.00% to 2.50% of one or more paraffin wax emulsions, about 1.70% of one or more paraffin wax emulsions, or about 2.00% of one or more paraffin wax emulsions. Examples of paraffin wax emulsions of the present disclosure include MICHEM Emulsion 70750 (anionic paraffin wax emulsion), REPSOL REDEMUL (anionic paraffin wax emulsion), and MICRO POWDERS AQUABEAD 325E (anionic paraffin wax emulsion).

The one or more carnauba wax emulsions can include an anionic and/or a nonionic carnauba wax emulsion. In embodiments, compositions of the present disclosure can include by total weight of the composition about 1.00% to 5.00% of one or more carnauba wax emulsions, about 2.00% to 4.00% of one or more carnauba wax emulsions, or about 3.00% of one or more carnauba wax emulsions. Example carnauba wax emulsions of the present disclosure include MICHEM Emulsion 64422 (anionic carnauba wax emulsion), MICRO POWDERS AQUABEAD 425E (anionic carnauba wax emulsion), MICRO POWDERS AQUAKLEAN 418 (anionic carnauba wax emulsion), AQUACER 581 (nonionic carnauba based wax emulsion), and HYDROCER EC-36 (anionic carnauba wax emulsion).

The one or more silicone emulsions can include one or more amino-functionalized silicone emulsions. The amino-functionalized silicone emulsion includes an aminoalkyl-functionalized organopolysiloxane, one or more wetting agents, and water. In embodiments, the amino-functionalized silicone emulsion includes B amine-alkyl/dimethyl silicone polymer and one or more wetting agents, such as alcohol ethoxylates that are commonly used to emulsify the silicones in water. In embodiments, the one or more silicone emulsions can include one or more of an amino-functionalized polydimethylsiloxanes, a polar amine/alkyl functional block, and an amine/alkoxy end-blocked silicone. In embodiments, compositions of the present disclosure can include by total weight of the composition about 0.50% to 3.00% of one or more silicone emulsions, about 1.00% to 2.00% of one or more silicone emulsions, about 1.250% of one or more silicone emulsions, or about 1.500% of one or more silicone emulsions. Example silicone emulsions of the present disclosure includes SILTECH E-4155 (aminoalkyl-functional silicone emulsion) and WACKER L 656 (aminoalkyl-functional polydimethylsiloxane).

The one or more film formers can include one or more silicone-based polymers. In some cases, the one or more film formers can include one or more cyclic siloxanes, such as cyclopentasiloxane (decamethylcyclopentasiloxane, D5), octamethylcyclotetrasiloxane (D4), and dodecamethylcyclohexasiloxane (D6), and/or one or more branched, three-dimensional siloxane, such as trimethylsiloxysilicate and polypropyl silsesquioxane. In embodiments, the one or more film formers can include a combination of cyclopentasiloxane and trimethylsiloxysilicate, or a combination of trimethylsiloxy silicate and polypropyl silsesquioxane. In embodiments, compositions of the present disclosure can include by total weight of the composition about 0.05% to 7.00% of one or more film formers, about 0.10% to 2.00% of one or more film formers, about 2.00% to 5.00% of one or more film formers, about 0.590% of one or more film formers, about 3.70% of one or more film formers, or about 4.00% of one or more film formers. Examples of film formers of the present disclosure include DOWSIL RSN0749, MOMENTIVE SS4230 silicone resin, and CQsil Q5 LK-Q5.

The one or more preservatives can include one or more of hydantoin germicide, carbamate fungicide, benzisothiazolinone (BIT), methylisothiazolinone (MIT), and methylchloroisothiazolinone (CMIT). In embodiments, the one or more preservatives include BIT. In embodiments, the preservative can include BIT, CMIT, and MIT. The one or more preservatives may be an optional ingredient if desired, such as in cases where the compositions are used immediately, and where long-term shelf stability is not necessary. In embodiments, compositions of the present disclosure can include by total weight of the composition about 0.05% to 0.50% of one or more preservatives, about 0.179% of one or more preservatives, or about 0.200% of one or more preservatives. Example of a preservatives of the present disclosure include ACTICIDE B 20 (BIT), TROYGUARD BC11 (BIT, CMIT, and MIT), and MERGAL 758 (BIT, CMIT, and MIT).

The one or more dyes can include one or more water-soluble colorants. In embodiments, the one or more dyes can include a color based on commercial market demand, and visual appeal. As an example, the one or more dyes can include a yellow color. In embodiments, compositions of the present disclosure can include by total weight of the composition about 0.01% to 0.10% of one or more dyes, or about 0.050% of one or more dyes. An example of a dye of the present disclosure includes D11050 CHROMATINT Yellow RS liquid.

In embodiments, the fragrance can include a fragrance based on commercial market demand, and sensory satisfaction. As an example, the fragrance can include a tropical aroma. The fragrance of the compositions of the present disclosure can be an optional ingredient. In embodiments, the compositions of the present disclosure can include by total weight of the composition about 0.05% to 0.30% of the fragrance, or about 0.100% of the fragrance. An example of a fragrance of the present disclosure includes Pineapple Whip 861357.

In embodiments, the one or more rheology modifiers can include a cellulose-based polymer. For example, the one or more rheology modifiers can include one or more of cellulose, xanthan gum, or cellulose gum. In embodiments, the one or more rheology modifiers can include a combination of cellulose, xanthan gum, and cellulose gum. In embodiments, compositions of the present disclosure can include by total weight of the composition about 1.00% to 15.00% of one or more rheology modifiers, about 2.00% to 10.00% of one or more rheology modifiers, about 4.00% to 7.00% of one or more rheology modifiers, or about 5.00% of one or more rheology modifiers. An example of a rheology modifiers of the present disclosure includes RHEOZAN BLC (cellulose).

The compositions descried herein can include water, an anionic paraffin wax emulsion, an anionic carnauba wax emulsion, and one or more silicone-based film formers. In embodiments, the compositions can optionally include one or more alcohol ethoxylates, an amino-functionalized silicone emulsion, a cellulose-based polymer, one or more preservatives, one or more dyes, and/or a fragrance. For example, the compositions can include, deionized water, two C12-C14 secondary alcohol ethoxylates, an anionic paraffin wax emulsion, an anionic carnauba wax emulsion, an amino-functionalized silicone emulsion, and a cyclic siloxane and/or a branched, three-dimensional siloxane, and optionally a preservative including BIT, a water soluble yellow colorant, and/or a fragrance with pineapple whip aroma. For example, the compositions can include, deionized water, an anionic paraffin wax emulsion, an anionic carnauba wax emulsion, and a cyclic siloxane and/or a branched, three-dimensional siloxane, and optionally a cellulose-based polymer, a preservative including BIT, a water soluble yellow colorant, and/or a fragrance with pineapple whip aroma.

In embodiments, each of the components of the compositions described herein can be a substance including a main ingredient or a mixture including a main ingredient and other ingredients, such as water and other solvents. In some cases, a substance used herein may include a small amount of impurities. In some cases, a mixture used herein may also include small amounts of impurities, and/or other ingredients in unreportable levels. For example, DOWSIL RSN0749, an example of a film former, is a mixture including about 40.0% to about 50.0% w/w decamethylcyclopentasiloxane as the main ingredient. For example, TERGITOL 15-S-7, an example of a wetting agent including about 97% C12-14-secondary ethoxylated alcohols as the main ingredient, and TERGITOL 15-S-3, an example of a wetting agent including about 99% C12-14-secondary ethoxylated alcohols as the main ingredient. For example, RHEOZAN BLC, an example of a rheology modifier, is a mixture including water, cellulose, cellulose gum, xanthan gum, and glycerin. RHEOZAN BLC includes about 1-5% w/w cellulose. For example, ACTICIDE B 20, an example of a preservative, is a mixture including about 20% w/w 1,2-benzisothiazol-3 (2H)-one and about 1-3% sodium hydroxide. For example, TROYGUARD BC-11, an example preservative, can include 10.1% w/w benzothiazole-3 (2h)-one (BIT) as the main ingredient, and 0.5% w/w 5-chloro-2-methyl-4-isothiazolin-3-one (CMIT), and 0.16% w/w 2-methyl-2H-isothiazol-3-one (MIT).

The present disclosure describes methods of preparing the compositions presented herein. In embodiments, the methods can include adding water to a container; while agitating the water, adding in one or more film formers and one or more silicone emulsions and mixing for about 5 minutes (mins) to 15 mins, or about 10 mins; and adding in one or more paraffin wax emulsions and one or more carnauba wax emulsions, and mixing from 10 mins to 20 mins, or about 15 mins to obtain the composition. In embodiments, the mixing is continuous as the composition is prepared.

In embodiments, the method can include, prior to adding the one or more film formers to the solvent, adding one or more preservatives to the solvent and mixing for about 10 to 20 mins; after mixing the one or more preservatives in the solvent, adding one or more rheology modifiers to the solvent and mixing for about 30 mins; after mixing the one or more rheology modifiers in the solvent, adding a fragrance and mixing for about 2 mins to 10 mins; and/or after mixing the one or more wax emulsions, adding one or more dyes to the composition and mixing for about 5 mins to 20 mins.

In embodiments, the method can include, prior to adding the one or more film formers to the solvent, adding one or more preservatives to the solvent and mixing for about 10 to 20 mins; after mixing the one or more preservatives in the solvent, adding a fragrance and mixing for about 2 mins to 10 mins; adding one or more silicone emulsions to the mixture with, or sequentially after, the one or more film formers and mixing for about 5 mins to 15 mins; after mixing the one or more wax emulsions, adding one or more wetting agents to the composition and mixing for about 10 mins to 20 mins; and/or after mixing the one or more wetting agents, adding one or more dyes to the composition and mixing for 5 mins to 20 mins. In embodiments, the methods can include storing the composition at room temperature, for example above freezing (0° C.) and below about 38° C.

The present disclosure describes methods of protecting an exterior surface, wherein the method can include applying a composition of the present disclosure to a surface and allowing the composition to form a protective film on the surface. In some cases, prior to dispensing the composition, the fluid can be mixed, for example by stirring, shaking, or otherwise agitating the composition. For example, mixing, shaking, and/or agitating the composition can distribute the composition into in a substantially uniform emulsion. The composition can be applied to a surface directly, for example by spraying one spray or pouring a small amount of the composition to a portion of the surface. In embodiments, compositions may be dispensed from a trigger/spray bottle which provides a fine mist and even application of the composition to a surface. The composition can then be spread onto the surface using a towel, sponge, cloth, or squeegee. In some cases, the composition can be applied to an applicator, such as a towel, sponge, cloth, or squeegee, and then the applicator can be used to spread the composition onto a surface. Once the composition is spread onto the surface, it can then be buffed to form a streak-free finish. For example, the composition can be buffed with a clean dry towel, sponge, or cloth, including a clean dry side of an applicator used to apply the composition to the surface. In some cases, the composition can cure rapidly, for example in about 15 seconds to 2 minutes. To ensure even, streak-free application of the composition, the method of using can be repeated on small portions of the surface until the entire surface is treated. In embodiments, the compositions described herein can be applied to wet or dry surfaces. In some cases, the surface is clean and at a temperature in a rage of about 0° C. to 85° C., for example in a range of about 2° C. to 75° C., about 3° C. to 65° C., about 5° C. to 55° C., about 10° C. to 45° C. or about 10° C. to 38° C.

In embodiments, compositions described herein minimize streaking and buffing time when applied to surfaces. In embodiments, the protective film is formed within 15 seconds to 2 mins. Examples of exterior surface include a metal surface, a painted surface, a plastic surface, or rubber surface. In embodiments, the exterior surface can include the exterior surface of a vehicle, such as the surface of a wheel, trim, chrome, hood, roof, door, or headlight. In embodiments, the method can further provide shine to the exterior surface.

The terms “composition(s)” and “formulation(s)” are used interchangeably to refer to the compositions described herein.

The term “wt %” or “%” in the context of the weight of the component in the composition are used interchangeably to be relative to the total weight of the composition.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means has, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition, for example, for protecting a surface by providing improved durability and water repellency, as well as improved appearance of a surface by enhancing gloss, color depth, and shine.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments:
1. A composition including:
   a solvent;
   one or more wax emulsions; and
   one or more film formers; and
   optionally:
   one or more wetting agents;
   one or more silicone emulsions;
   one or more rheology modifiers;
   one or more preservatives;
   one or more dyes; and/or
   a fragrance.
2. The composition of embodiment 1, wherein the composition includes by total weight of the composition:
   about 80.00% to 95.00% of the solvent;
   about 0.50% to 8.00% of one or more wax emulsions; and
   about 0.05% to 7.00% of one or more film formers; and
   optionally:
   about 0.50% to 3.00% of one or more wetting agents;
   about 0.50% to 3.00% of one or more silicone emulsions;
   about 1.00% to 8.00% of one or more rheology modifiers,
   about 0.05% to 0.50% of one or more preservatives;
   about 0.01% to 0.10% of one or more dyes; and/or
   about 0.05% to 0.30% of the fragrance.
3. The composition of embodiment 1 or 2, wherein the solvent is distilled water, demineralized water, deionized water, or reverse osmosis water.
4. The composition of any one of embodiments 1-3, wherein the one or more wax emulsions include one or more paraffin wax emulsions and/or one or more carnauba wax emulsions.
5. The composition of embodiment 1-4, wherein the one or more wax emulsions include an anionic and/or nonionic paraffin wax emulsion.
6. The composition of embodiment 1-5, wherein the one or more wax emulsions include an anionic and/or a nonionic carnauba wax emulsion.
7. The composition of any one of embodiments 1-6, wherein the one or more film formers include a cyclic siloxane and/or a branched, three dimensional siloxane.
8. The composition of any one of embodiments 1-7, wherein the one or more film formers include a combination of cyclopentasiloxane and trimethylsiloxysilicate, and/or a combination of trimethylsiloxy silicate and polypropyl silsesquioxane.
9. The composition of any one of embodiments 1-8, wherein the one or more wetting agents include alcohol ethoxylates.
10. The composition of any one of embodiments 1-9, wherein the one or more wetting agents have a hydrophilic-lipophilic balance (HLB) of about 7-15.
11. The composition of any one of embodiments 1-10, wherein the one or more wetting agents include a first wetting agent including C12-C14 secondary alcohol ethoxylates and a second wetting agent including C12-C14 secondary alcohol ethoxylates, and optionally wherein the first wetting agent has a HLB of 8 and the second wetting agent has a HLB of 12.1.
12. The composition of any one of embodiments 1-11, wherein the one or more silicone emulsions include one or more amino-functionalized silicone emulsions, and optionally wherein the amino-functionalized silicone emulsion includes B amine-alkyl/dimethyl silicone polymer, one or more wetting agents that can emulsify silicones, and water, and optionally the wetting agents include one or more alcohol ethoxylates.
13. The composition of any one of embodiments 1-12, wherein the one or more silicone emulsions include amino-functionalized polydimethylsiloxane, a polar amine/alkyl functional block, and/or an amine/alkoxy end-blocked silicone.
14. The composition of any one of embodiments 1-13, wherein the one or more rheology modifiers include cellulose and/or a cellulose-based polymer.
15. The composition of any one of embodiments 1-14, wherein the one or more rheology modifiers include cellulose, xanthan gum, cellulose gum, or combinations thereof.
16. The composition of any one of embodiments 1-15, wherein the one or more preservatives include hydantoin germicide, carbamate fungicide, benzisothiazolinone (BIT), methylisothiazolinone (MIT), and/or methylchloroisothiazolinone (CMIT), and optionally the one or more preservatives include BIT, MIT, and CMIT.
17. The composition of any one of embodiments 1-16, wherein the one or more dyes include one or more water soluble colorants, and optionally the one or more water soluble colorants includes a yellow colorant.
18. The composition of any one of embodiments 1-17, wherein the fragrance includes one or more water miscible fragrance oils, and optionally the fragrance has a pineapple whip aroma.
19. The composition of any one of embodiments 1-18, wherein the composition includes:
   water;
   an anionic paraffin wax emulsion;
   an anionic carnauba wax emulsion; and
   a cyclic siloxane and/or a branched, three-dimensional siloxane; and
   optionally:
   one or more alcohol ethoxylates;
   an amino-functionalized silicone emulsion;
   a cellulose-based polymer;
   a preservative;
   a dye; and/or
   a fragrance.
20. The composition of any one of embodiments 1-19, wherein the composition includes by total weight of the composition:
   about 80.00% to 95.00% deionized water;
   about 0.50% to 3.00% of an anionic paraffin wax emulsion;
   about 1.00% to 5.00% of an anionic carnauba wax emulsion; and
   about 0.05% to 7.00% of a mixture including cyclopentasiloxane and trimethylsiloxysilicate; and
   optionally:
   about 0.50% to 3.00% of one or more C12-C14 secondary alcohol ethoxylates;
   about 0.50% to 3.00% of an amino-functionalized silicone emulsion;
   about 1.00% to 10.00% of a mixture including cellulose;
   about 0.05% to 0.50% of a preservative including BIT, and optionally, wherein the preservative includes BIT, MIT, and CMIT;
   about 0.01% to 0.10% of a water soluble yellow colorant; and/or
   about 0.05% to 0.30% of a fragrance with pineapple whip aroma.
21. The composition of any one of embodiments 1-20, wherein the composition includes by total weight of the composition:
   about 92.141% deionized water;
   about 0.690% of a first C12-C14 secondary alcohol ethoxylate;
   about 0.300% of a second C12-C14 secondary alcohol ethoxylate;
   about 1.70% of an anionic paraffin wax emulsion;
   about 3.00% of an anionic carnauba wax emulsion;
   about 1.250% of an amino-functionalized polydimethylsiloxane emulsion;
   about 0.590% of a mixture including cyclopentasiloxane and trimethylsiloxysilicate;
   about 0.179% of a preservative including BIT, and optionally, wherein the preservative includes BIT, MIT, and CMIT;
   about 0.050% of a water soluble yellow colorant; and
   about 0.100% of a fragrance with pineapple whip aroma.
22. The composition of any one of embodiments 1-20, wherein the composition includes by total weight of the composition:
   about 88.521% deionized water;
   about 1.000% of a first C12-C14 secondary alcohol ethoxylate;
   about 0.500% of a second C12-C14 secondary alcohol ethoxylate;
   about 1.700% anionic paraffin wax emulsion;
   about 3.000% anionic carnauba wax emulsion;
   about 1.250% amino-functionalized polydimethylsiloxane emulsion;
   about 3.700% of a mixture including cyclopentasiloxane and trimethylsiloxysilicate;
   about 0.179% of a preservative including BIT, and optionally, wherein the preservative includes BIT, MIT, and CMIT;
   about 0.050% of a water soluble yellow colorant; and
   about 0.100% of a fragrance with pineapple whip aroma.
23. The composition of any one of embodiments 1-20, wherein the composition includes by total weight of the composition:
   about 87.650% deionized water;
   about 1.000% of a first C12-C14 secondary alcohol ethoxylate;
   about 0.500% of a second C12-C14 secondary alcohol ethoxylate;
   about 2.000% of an anionic paraffin wax emulsion;
   about 3.000% of an anionic carnauba wax emulsion;
   about 1.500% of an amino-functionalized polydimethylsiloxane emulsion;
   about 4.000% of a mixture including cyclopentasiloxane and trimethylsiloxysilicate;
   about 0.200% of a preservative including BIT, and optionally, wherein the preservative includes BIT, MIT, and CMIT;
   about 0.050% of a water soluble yellow colorant; and
   about 0.100% of a fragrance with pineapple whip aroma.
24. The composition of any one of embodiments 1-20, wherein the composition includes by total weight of the composition:
   about 89.460% deionized water;
   about 1.700% of an anionic paraffin wax emulsion;
   about 3.000% of an anionic carnauba wax emulsion;
   about 0.590% of a mixture including cyclopentasiloxane and trimethylsiloxysilicate;
   about 5.000% of a mixture including cellulose;
   about 0.100% of a preservative including BIT, CMIT, and MIT;
   about 0.050% of a water soluble yellow colorant; and
   about 0.100% of a fragrance with pineapple whip aroma.
25. The composition of any one of embodiments 1-20, wherein the composition includes by total weight of the composition:
   about 89.385% deionized water;
   about 1.700% of an anionic paraffin wax emulsion;
   about 3.000% of an anionic carnauba wax emulsion;
   about 0.590% of a mixture including cyclopentasiloxane;
   about 5.000% of a mixture including cellulose;
   about 0.175% of a preservative including BIT;
   about 0.050% of a water soluble yellow colorant; and
   about 0.100% of a fragrance with pineapple whip aroma.
26. A method of preparing the composition of any one of embodiments 1-25, wherein the method includes adding the solvent to a container; while agitating the solvent, adding in the one or more film formers to the solvent and mixing for about 5 minutes (mins) to 15 mins to form a mixture; and adding in the one or more wax emulsions to the mixture, and mixing from 10 mins to 20 mins to obtain the composition; and wherein mixing is continuous as the composition is prepared.
27. The method of embodiment 26, wherein the method further includes adding the one or more silicone emulsions to the mixture with, or sequentially after, the one or more film formers.
28. The method of embodiment 26 or 27, wherein the method further includes adding the one or more wetting agents to the composition after the one or more wax emulsions and mixing for 10 mins to 20 mins.
29. The method of any one of embodiments 26-28, wherein the method further includes adding the one or more rheology modifiers to the composition and mixing for 30 mins.
30. The method of any one of embodiments 26-29, wherein the method further includes, before adding in the one or more film formers and while agitating the solvent, adding the one or more preservatives to the solvent and mixing for about 10 to 20 mins.
31. The method of embodiment 30, wherein the method further includes, after mixing the one or more preservatives in the solvent, adding the fragrance, and mixing for about 2 mins to 10 mins.
32. The method of any one of embodiments 28-31, wherein the method further includes, after mixing the one or more wetting agents, adding the one or more dyes to the mixture and mixing for 5 mins to 20 mins.
33. The method of any one of embodiments 26-32, wherein the method further includes storing the composition at room temperature.
34. A method of protecting an exterior surface, wherein the method includes applying the composition of any one of embodiments 1-25 to a surface and allowing the composition to form a protective film on the surface.
35. The method of embodiment 34, wherein the protective film is formed within 15 seconds to 2 mins.
36 The method of embodiment 34 or 35, wherein the composition is sprayed on an exterior surface or an interior surface.
37. The method of embodiment 36, wherein the exterior surface includes a metal surface, a painted surface, a plastic surface, a rubber surface, or a glass surface.
38 The method of embodiment 36 or 37, wherein the exterior surface includes the exterior surface of a vehicle.
39. The method of any one of embodiments 36-38, wherein the exterior surface includes the surface of wheel, trim, chrome, hood, roof, door, or headlight.
40. The method of any one of embodiments 34-39, wherein the composition further provides shine to the surface.

### EXAMPLES

Representative embodiments of the present disclosure will now be described with reference to the following examples that illustrate the principles and practice of the present disclosure.

### Example 1

Example 1 provides an exemplary composition of the present disclosure. Example Composition 1 is given in Table 1.

TABLE 1
Example Composition 1

| | | Component Quantity |
|---|---|---|
| | | wt % (by total weight |
| Component | Function | of the composition) |
| DI Water | Solvent | 92.141% |
| ACTICIDE B20 | Preservative | 0.179% |
| Fragrance Pineapple | Fragrance | 0.100% |
| Whip | | |
| DOWSIL RSN-0749 | Film forming | 0.590% |
| SILTECH E-4155 | Color depth and | 1.250% |
| | gloss | |
| MICHEM Emulsion 70750 | Gloss, repellency, | 1.700% |
| | and durability | |
| MICHEM Emulsion 64422 | Gloss | 3.000% |
| TERGITOL 15-S-7 | Wetting agent | 0.690% |
| TERGITOL 15-S-3 | Wetting Agent | 0.300% |
| D11050 CHROMATINT | Dye | 0.050% |
| Yellow RS Liquid | | |
| Total | | 100.00 |

The composition was prepared first by preparing the tank being used by ensuring it had been cleaned and sanitized and was empty, ensuring the correct valves were open and the remainder were closed, and then a) pumping the required amount of water into the tank, b) starting the agitator (mixing was sufficient to impart fluid motion to the batch and the batch was kept under continuous mixing), c) adding the ACTICIDE B20 and mixing for 15 mins, d) adding the Pineapple Whip 861357 fragrance and mixing for 5 mins, e) adding the DOWSIL RSN-0749 and SILTECH E-4155 and mixing for 10 mins, f) adding the MICHEM Emulsion 70750 and MICHEM Emulsion 64422 and mixing for 15 mins, g) adding the TERGITOL 15-S-7 and TERGITOL 15-S-3 and mixing for another 15 mins, and h) adding the D11050 CHROMATINIT Yellow RS Liquid followed by mixing for 10 mins.

### Example 2

Example 2 provides an exemplary composition of the present disclosure. Example Composition 2 is given in Table 2.

TABLE 2
Example Composition 2

| | | Component Quantity |
|---|---|---|
| | | wt % (by total weight |
| Component | Function | of the composition) |
| DI Water | Solvent | 88.521% |
| ACTICIDE B20 | Preservative | 0.179% |
| Frag Pineapple Whip | Fragrance | 0.100% |
| DOWSIL RSN-0749 | Film forming | 3.700% |
| SILTECH E-4155 | Color depth and | 1.250% |
| | gloss | |
| MICHEM Emulsion 70750 | Gloss, repellency, | 1.700% |
| | and durability | |
| MICHEM Emulsion 64422 | Gloss | 3.000% |
| TERGITOL 15-S-7 | Wetting agent | 1.000% |
| TERGITOL 15-S-3 | Wetting Agent | 0.500% |
| D11050 CHROMATINT | Dye | 0.050% |
| Yellow RS Liquid | | |
| Total | | 100.00 |

The composition was prepared in the same way as Example 1.

### Example 3

Example 3 provides an exemplary composition of the present disclosure. Example Composition 3 is given in Table 3.

TABLE 3
Example Composition 3

| | | Component Quantity |
|---|---|---|
| | | wt % (by total weight |
| Component | Function | of the composition) |
| DI Water | Solvent | 87.650% |
| ACTICIDE B20 | Preservative | 0.200% |
| Frag Pineapple Whip | Fragrance | 0.100% |
| DOWSIL RSN-0749 | Film forming | 4.000% |
| SILTECH E-4155 | Color depth and | 1.500% |
| | gloss | |
| MICHEM Emulsion 70750 | Gloss, repellency, | 2.000% |
| | and durability | |
| MICHEM Emulsion 64422 | Gloss | 3.000% |
| TERGITOL 15-S-7 | Wetting agent | 1.000% |
| TERGITOL 15-S-3 | Wetting Agent | 0.500% |
| D11050 CHROMATINT | Dye | 0.050% |
| Yellow RS Liquid | | |
| Total | | 100.00 |

The composition was prepared in the same way as Example 1.

### Example 4

Example 4 provides an exemplary composition of the present disclosure. Example Composition 4 is given in Table 4.

TABLE 4
Example Composition 4

| | | Component Quantity |
|---|---|---|
| | | wt % (by total weight |
| Component | Function | of the composition) |
| DI Water | Solvent | 89.460% |
| TROYGUARD BC-11 | Preservative | 0.100% |
| Frag Pineapple Whip | Fragrance | 0.100% |
| DOWSIL RSN-0749 | Film forming | 0.590% |
| RHEOZAN BLC | Rheology Modifier | 5.000% |
| MICHEM Emulsion 70750 | Gloss, repellency, | 1.700% |
| | and durability | |
| MICHEM Emulsion 64422 | Gloss | 3.000% |
| D11050 CHROMATINT | Dye | 0.050% |
| Yellow RS Liquid | | |
| Total | | 100.00 |

The composition was prepared first by preparing the tank being used by ensuring it had been cleaned and sanitized and was empty, ensuring the correct valves are open and the remainder are closed, and then a) pumping the required amount of water into the tank, b) starting the agitator (mixing was sufficient to impart fluid motion to the batch and the batch was kept under continuous mixing), c) adding the TROYGUARD BC-11 and mixing for 15 mins, d) adding the RHEOZAN BLC and mixing for another 30 mins, e) adding the Pineapple Whip 861357 fragrance and mixing for 5 mins, f) adding the DOWSIL RSN-0749 and mixing for 10 mins, g) adding the MICHEM Emulsion 70750 and MICHEM Emulsion 64422 and mixing for 15 mins, and h) adding the D11050 CHROMATINT Yellow RS Liquid followed by mixing for 10 mins.

### Example 5

Example 5 provides an exemplary composition of the present disclosure. Example Composition 5 is given in Table 5.

TABLE 5
Example Composition 5

| | | Component Quantity |
|---|---|---|
| | | wt % (by total weight |
| Component | Function | of the composition) |
| DI Water | Solvent | 89.385% |
| ACTICIDE B20 | Preservative | 0.175% |
| Frag Pineapple Whip | Fragrance | 0.100% |
| DOWSIL RSN-0749 | Film forming | 0.590% |
| RHEOZAN BLC | Rheology Modifier | 5.000% |
| MICHEM Emulsion 70750 | Gloss, repellency, | 1.700% |
| | and durability | |
| MICHEM Emulsion 64422 | Gloss | 3.000% |
| D11050 CHROMATINT | Dye | 0.050% |
| Yellow RS Liquid | | |
| Total | | 100.00 |

The composition was prepared in the same way as Example 4, where ACTICIDE B20 is added in place of TROTGUARD BC-11.

### Experimental Example 1

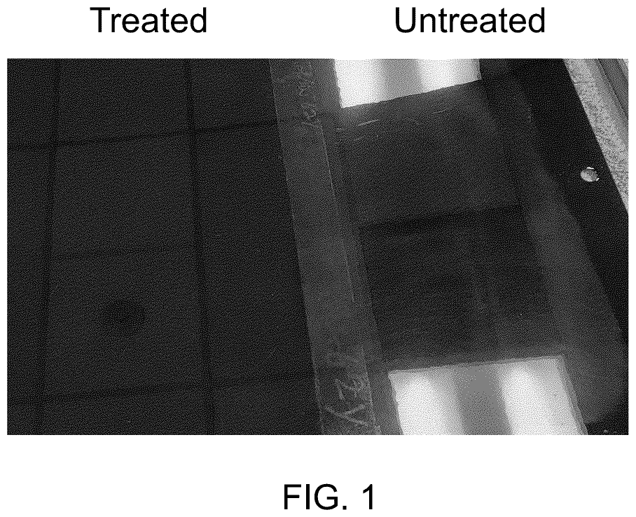

FIG. 1 shows performance testing results of a composition of the present disclosure on a painted surface. The right side of FIG. 1 depicts the untreated condition of the surface, and the left side of FIG. 1 depicts the surface after it was treated with the Example Composition 2. The treated surface is shinier than the untreated surface. The composition adds gloss and shine to the surface.

Table 6 shows performance data for Example Composition 2 compared with compositions currently available on the market. Durability testing value of “=” represents equal performance among the compositions, and the symbol “<” represents performance that is less than the other compositions.

TABLE 6
Product Performance Data

| | Example | Comparative | Comparative | Comparative | Comparative |
|---|---|---|---|---|---|
| | Composition 2 | Example 1 | Example 2 | Example 3 | Example 4 |
| Contact | 102.16 | 101.27 | 92.64 | 102.72 | 90.8 |
| Angle | | | | | |
| Gloss | 78.7 | 74.3 | 72.9 | 77.5 | 77.6 |
| Change in | −3.95 | −3.87 | −1.22 | −2.84 | −0.34 |
| Color (ΔL) | | | | | |
| Durability | = | = | = | = | < |
| After 3 | | | | | |
| washes | | | | | |

The data in Table 6 shows that after treatment with Example Composition 2, the surface has a higher contact angle than most compositions currently on the market indicating enhanced hydrophobicity or water beading. For hydrophobicity, a high value is preferable as this indicates a high repellency to water. The surface treated with Example Composition 2 also has a higher gloss value and a darker color (a lower L value indicates a darker surface) indicating it has a higher shine and improved color depth as compared to compositions currently on the market. Moreover, the durability of the coating provided by Example Composition 2 is just as good or better than the other compositions on the market.

### Experimental Example 2

Experimental Example 2 provides data to support that compositions of the present disclosure provide durable ceramic protection for over 1 year and that natural and synthetic waxes can intensify shine and improve color depth.

Experimental Example 2 uses contact angle measurements, gloss measurements, and color depth (colorimeter) measurements. Example Composition 4 was applied to a painted surface. Measurements were taken before and after application and then over 12 car washes to evaluate durability of the coating. 12 car washes were identified to be the equivalent to 12 months of durability of the coating based on an average consumer washing their car about 13 times a year.

Painted panels (i.e., that simulate the painted exterior of a vehicle) were treated with the Example Composition 4 as stated in the directions. Painted panels were selected as the test substrate as the painted area is the largest exterior surface and it the typically waxed area of a car. Contact angle, color depth measurements were taken before and after application. Then using a foam cannon and pressure washer, the panels were washed to simulate a touchless car wash. Measurements were taken every 3 washes to evaluate durability of the wax coating. The average American washes their car around 13 times per year, therefore the number of car washes can relate to months, i.e. about 1 year, of durability.

Example Composition 4 was the final formula selected for commercial production. This formulation contains 2 wax emulsions, MICHEM Emulsion 64422 & 70750. MICHEM 64422 is an anionic carnauba wax emulsion, which provides slip, abrasion and block resistance in auto and other polish formulations. MEM 70750 is a paraffin wax emulsion, that imparts excellent early water resistance and release properties when used as an additive.

Contact angle is explained by Young's equation of interfacial tensions, the intersection where liquid and solid interact. High contact angle suggests low wettability and better water repellency whereas a lower contact angle shows better wettability or spreading out of water onto the surface. In the case of a spray wax we would find a high contact angle more desirable.

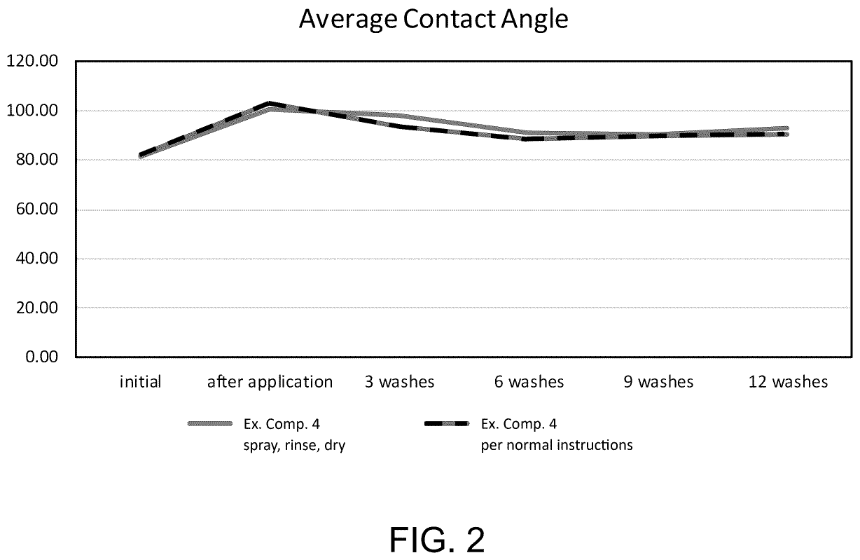

FIG. 2 shows contact angle initial value before application, after application and over 12 car washes. This graph shows a durable coating the reminds above the initial untreated surface.

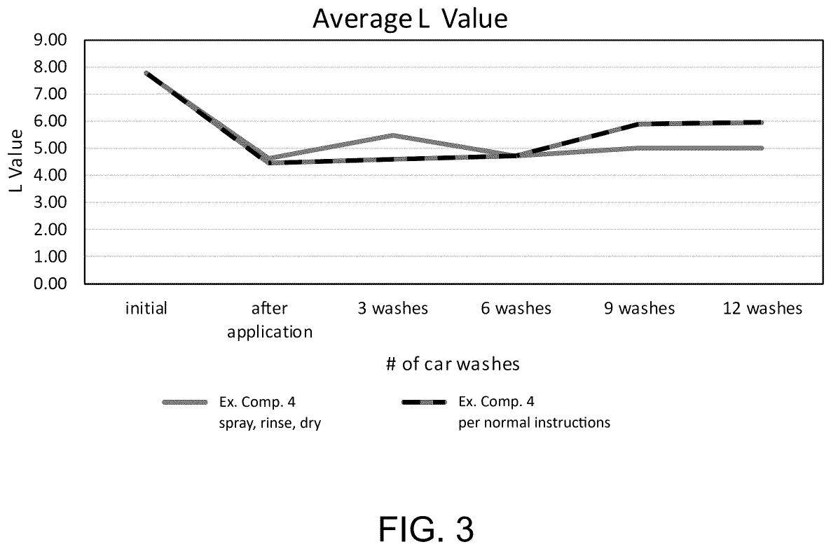

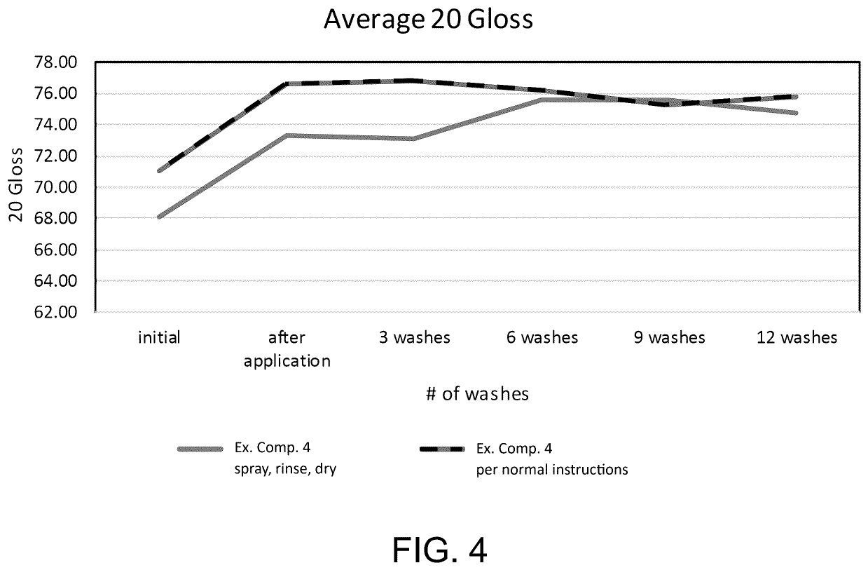

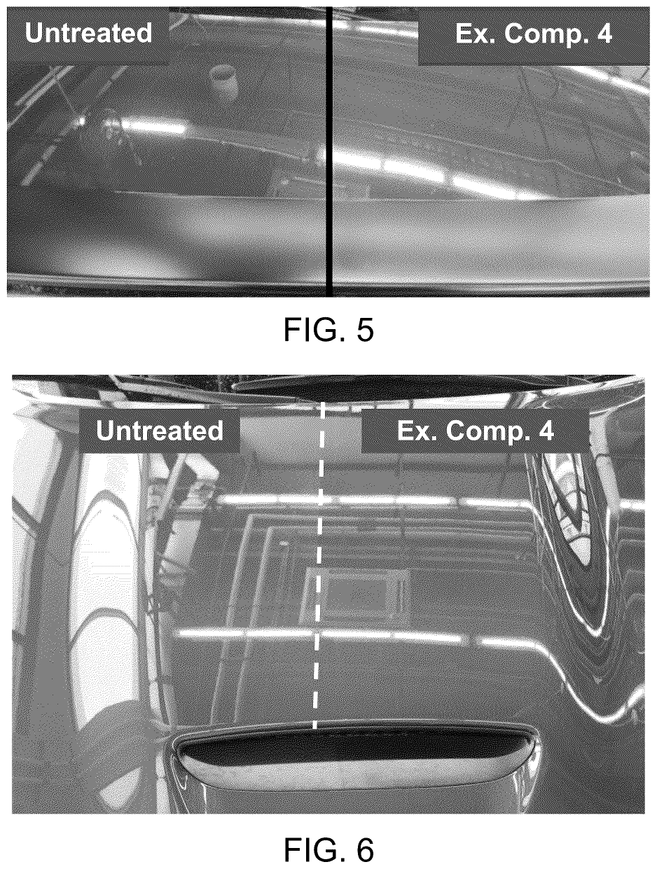

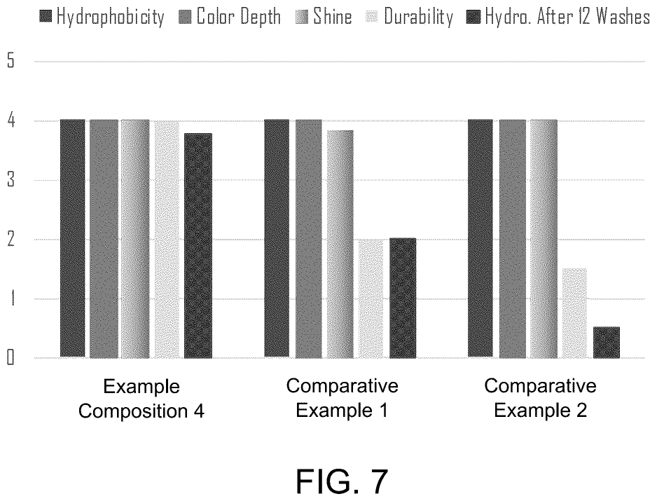

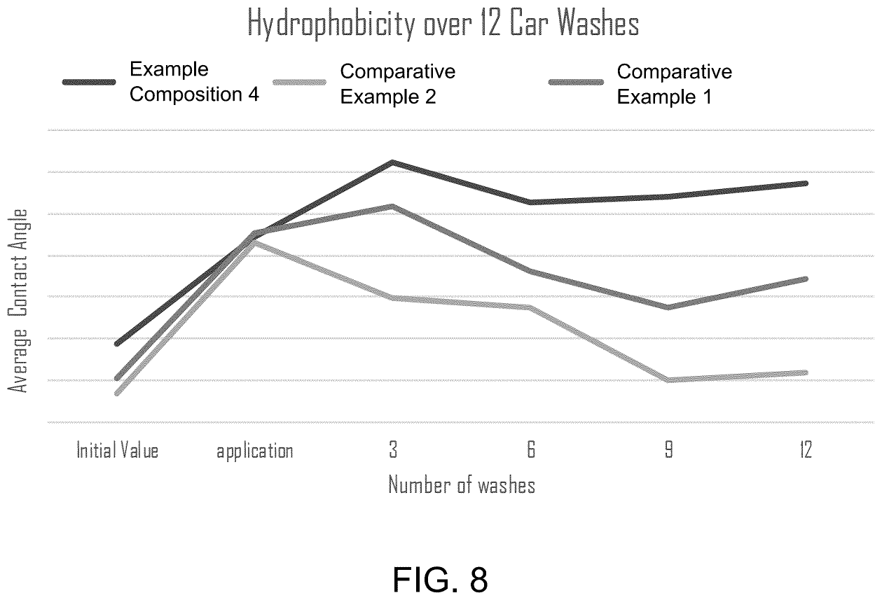

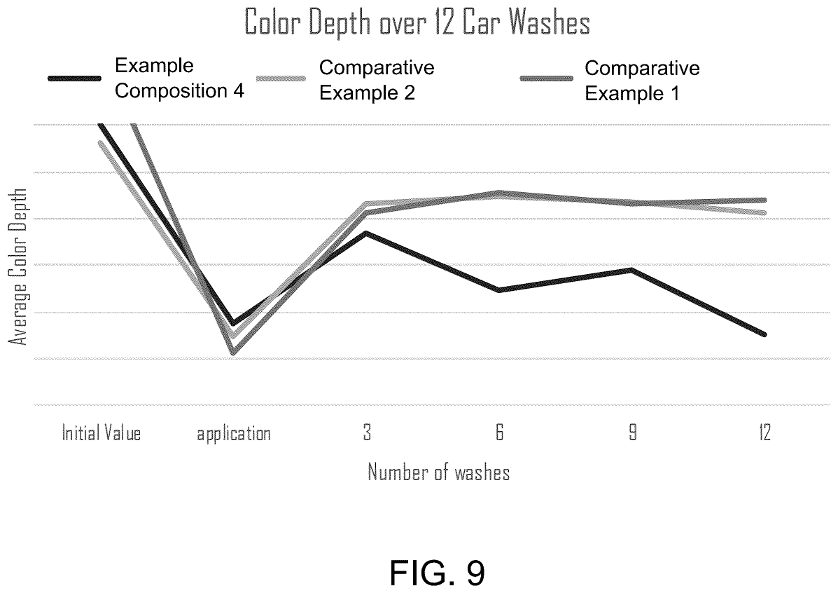

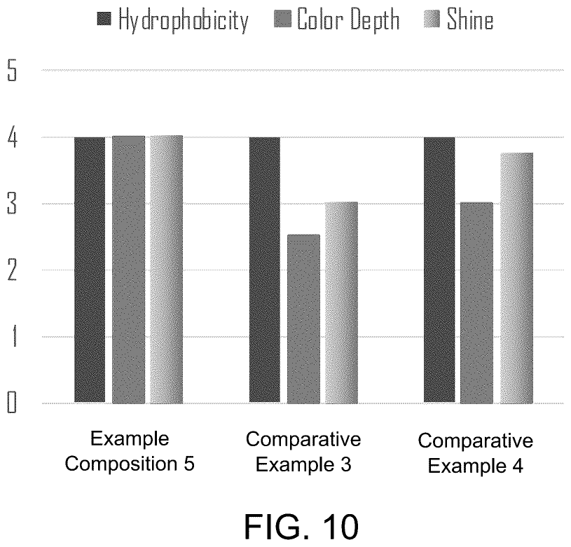

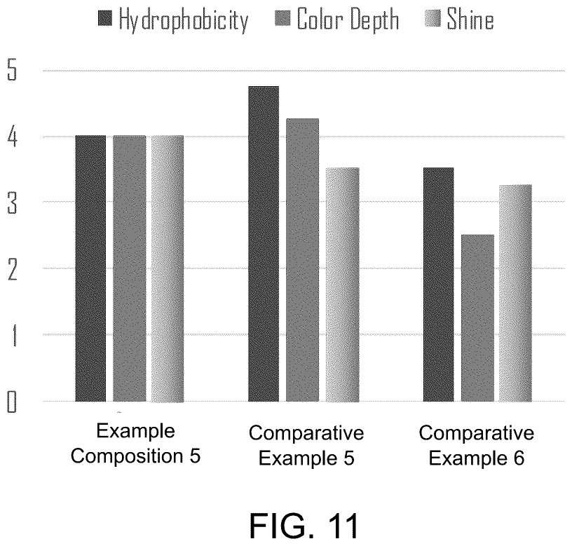

Color depth and gloss/shine measurements are collected by using different handheld spectrophotometers that non-invasively measure these properties. Color depth is reported as the “L value”. L values define color on a range from black (value 0) to white (value 100). A lower L value indicates a darker color, whereas a higher value could indicate lightening of color. Similarly, to contact angle, both color and gloss were measured before application and after Example Composition 4 and then over 12 car washes to evaluate durability. FIG. 3 and FIG. 4 show the change over 12 car washes. For color depth, after application of the composition there is drop in L value showing a darkening of the surface color. Gloss/shine incident light angle of 20 was selected as this is a high gloss surface and strong reflections can occur so for accurate measurements at low angle is used. When gloss was measured there is a gloss increase that is consistent over time when applied as directed. Both properties remain higher than the initial untreated surface indicating a durable coating.

### Experimental Example 3

Experimental Example 3 provides data to support for the safe use of compositions of the present disclosure on premium finishes such as carbon fiber, vinyl wraps, decals (film), and glossy, matte, and satin paint finishes. Example Composition 4 was applied to the indicated surface according to methods described herein (Surface Safety Normal condition) and they were heated to 85° C. (Surface Safety Misuse Condition). Damage was evaluated using the rating system in Table 7.

TABLE 7
Surface Safety Testing Rating System

| Rating | Meaning |
|---|---|
| 0 | No visible residue |
| 1 | Residue was successfully removed by wiping the surface with a |
| | damp microfiber cloth (DR water) |
| 2 | Residue was successfully removed with isopropyl alcohol (IPA) |
| 3 | Residue was successfully removed with AA cleaning wipe or |
| | multipurpose cleaner, and surface buffed |
| 4 | Residue was not successfully removed - FAIL |

TABLE 8
Surface Safety Testing Normal Condition

| Substrate | Finish | Cycle 1 | Cycle 2 | Cycle 3 | Cycle 4 |
|---|---|---|---|---|---|
| Vinyl Wrap | Matte | 0 | 0 | 0 | 0 |
| Transparent Film | Transparent | 0 | 0 | 0 | 0 |
| Transparent Film | Transparent | 0 | 0 | 0 | 0 |
| Vinyl Wrap | Matte | 0 | 0 | 0 | 0 |
| Vinyl Wrap | Satin | 0 | 0 | 0 | 0 |
| Vinyl Wrap | Satin | 0 | 0 | 0 | 0 |
| Vinyl Wrap | Satin | 0 | 0 | 0 | 0 |
| Vinyl Wrap | Matte | 0 | 0 | 0 | 0 |
| Vinyl Wrap | Iridescent | 0 | 0 | 0 | 0 |
| Vinyl Wrap | Satin | 0 | 0 | 0 | 0 |
| Vinyl Wrap | Iridescent | 0 | 0 | 0 | 0 |
| Vinyl Wrap | Gloss | 0 | 0 | 0 | 0 |
| Vinyl Wrap | Gloss | 0 | 0 | 0 | 0 |
| Vinyl Wrap | Gloss | 0 | 0 | 0 | 1 |
| Vinyl Wrap | Gloss | 0 | 0 | 0 | 0 |
| Carbon Fiber | — | 0 | 0 | 0 | 0 |

TABLE 9
Surface Safety Testing Misuse Condition (85° C.)

| Substrate | Finish | Cycle 1 | Cycle 2 | Cycle 3 | Cycle 4 |
|---|---|---|---|---|---|
| Vinyl Wrap | Matte | 2 | 2 | 2 | 2 |
| Transparent Film | Transparent | — | — | — | — |
| Transparent Film | Transparent | 1 | 1 | 3 | 3 |
| Vinyl Wrap | Matte | 1 | 1 | 1 | 1 |
| Vinyl Wrap | Satin | 1 | 1 | 1 | 1 |
| Vinyl Wrap | Satin | 1 | 2 | 1 | 1 |
| Vinyl Wrap | Satin | 1 | 1 | 2 | 2 |
| Vinyl Wrap | Matte | 2 | 2 | 2 | 2 |
| Vinyl Wrap | Iridescent | 1 | 1 | 1 | 1 |
| Vinyl Wrap | Satin | 1 | 1 | 1 | 1 |
| Vinyl Wrap | Iridescent | 1 | 1 | 1 | 1 |
| Vinyl Wrap | Gloss | 1 | 1 | 1 | 1 |
| Vinyl Wrap | Gloss | 1 | 1 | 1 | 1 |
| Vinyl Wrap | Gloss | 1 | 1 | 1 | 1 |
| Vinyl Wrap | Gloss | 1 | 1 | 1 | 1 |
| Carbon Fiber | — | 1 | 1 | 1 | 1 |

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It is to be understood that the examples and exemplary embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art.

Furthermore, numerous references have been made to patents, printed publications, journal articles, and other written text throughout this specification (referenced materials herein). Each of the referenced materials is individually incorporated herein by reference in their entirety for their referenced teaching.

### REFERENCES

1. Ouyang et al., Polymer Degradation and Stability, 70:2, 2000, p. 217-228
2. Freitas et al., Food Chemistry, Vol. 196, 2016, p. 1293-1300
3. Gaur & Sharma, International Research Journal of Engineering IT & Scientific Research, Vol. 06, 2018, p. 118-124
4. Tracy, David, DrivingPress, 2025. https://drivingpress.com/best-car-wax-uv-protection/

1. A composition comprising:
a solvent;
one or more wax emulsions; and
one or more film formers; and
optionally:
one or more wetting agents;
one or more silicone emulsions;
one or more rheology modifiers;
one or more preservatives;
one or more dyes; and/or
a fragrance.

2. The composition of claim 1, wherein the composition comprises by total weight of the composition:
about 80.00% to 95.00% of the solvent;
about 0.50% to 8.00% of one or more wax emulsions; and
about 0.05% to 7.00% of one or more film formers; and
optionally:
about 0.50% to 3.00% of one or more wetting agents;
about 0.50% to 3.00% of one or more silicone emulsions;
about 1.00% to 8.00% of one or more rheology modifiers;
about 0.05% to 0.50% of one or more preservatives;
about 0.01% to 0.10% of one or more dyes; and/or
about 0.05% to 0.30% of the fragrance.

3. The composition of claim 1, wherein the solvent is distilled water, demineralized water, deionized water, or reverse osmosis water.

4. The composition of claim 1, wherein the one or more wax emulsions comprise one or more paraffin wax emulsions and/or one or more carnauba wax emulsions.

5. The composition of claim 1, wherein the one or more wax emulsions comprise an anionic and/or nonionic paraffin wax emulsion.

6. The composition of claim 1, wherein the one or more wax emulsions comprise an anionic and/or a nonionic carnauba wax emulsion.

7. The composition of claim 1, wherein the one or more film formers comprise a cyclic siloxane and/or a branched, three dimensional siloxane.

8. The composition of claim 1, wherein the one or more film formers comprise a combination of cyclopentasiloxane and trimethylsiloxysilicate, and/or a combination of trimethylsiloxy silicate and polypropyl silsesquioxane.

9. The composition of claim 1, wherein the one or more wetting agents comprise alcohol ethoxylates.

10. The composition of claim 1, wherein the one or more wetting agents have a hydrophilic-lipophilic balance (HLB) of about 7-15.

11. The composition of claim 1, wherein the one or more wetting agents comprise a first wetting agent comprising C12-C14 secondary alcohol ethoxylates and a second wetting agent comprising C12-C14 secondary alcohol ethoxylates, and optionally wherein the first wetting agent has a HLB of 8 and the second wetting agent has a HLB of 12.1.

12. The composition of claim 1, wherein the one or more silicone emulsions comprise one or more amino-functionalized silicone emulsions, and optionally wherein the amino-functionalized silicone emulsion comprises B amine-alkyl/dimethyl silicone polymer, one or more wetting agents that can emulsify silicones, and water, and optionally the wetting agents comprise one or more alcohol ethoxylates.

13. The composition of claim 1, wherein the one or more silicone emulsions comprise amino-functionalized polydimethylsiloxane, a polar amine/alkyl functional block, and/or an amine/alkoxy end-blocked silicone.

14. The composition of claim 1, wherein the one or more rheology modifiers comprise cellulose and/or a cellulose-based polymer.

15. The composition of claim 1, wherein the one or more preservatives comprise hydantoin germicide, carbamate fungicide, benzisothiazolinone (BIT), methylisothiazolinone (MIT), and/or methylchloroisothiazolinone (CMIT), and optionally the one or more preservatives comprise BIT, MIT, and CMIT;
wherein the one or more dyes comprise one or more water soluble colorants, and optionally the one or more water soluble colorants comprises a yellow colorant; and/or
wherein the fragrance comprises one or more water miscible fragrance oils, and optionally the fragrance has a pineapple whip aroma.

16. The composition of claim 1, wherein the composition comprises:
water;
an anionic paraffin wax emulsion;
an anionic carnauba wax emulsion; and
a cyclic siloxane and/or a branched, three-dimensional siloxane; and
optionally:
one or more alcohol ethoxylates;
an amino-functionalized silicone emulsion;
a cellulose-based polymer;
a preservative;
a dye; and/or
a fragrance.

17. A method of preparing the composition of claim 1, wherein the method comprises adding the solvent to a container; while agitating the solvent, adding in the one or more film formers to the solvent and mixing for about 5 minutes (mins) to 15 mins to form a mixture; and adding in the one or more wax emulsions to the mixture, and mixing from 10 mins to 20 mins to obtain the composition; and wherein mixing is continuous as the composition is prepared.

18. The method of claim 17, wherein the method further comprises adding the one or more silicone emulsions to the mixture with, or sequentially after, the one or more film formers;
wherein the method further comprises adding the one or more wetting agents to the composition after the one or more wax emulsions and mixing for 10 mins to 20 mins;
wherein the method further comprises adding the one or more rheology modifiers to the composition and mixing for 30 mins;
wherein the method further comprises, before adding in the one or more film formers and while agitating the solvent, adding the one or more preservatives to the solvent and mixing for about 10 to 20 mins, and optionally
wherein the method further comprises, after mixing the one or more preservatives in the solvent, adding the fragrance, and mixing for about 2 mins to 10 mins;
wherein the method further comprises, after mixing the one or more wetting agents, adding the one or more dyes to the mixture and mixing for 5 mins to 20 mins; and/or
wherein the method further comprises storing the composition at room temperature.

19. A method of protecting an exterior surface, wherein the method comprises applying the composition of claim 1 to a surface and allowing the composition to form a protective film on the surface.

20. The method of claim 19, wherein the protective film is formed within 15 seconds to 2 mins.

21. The method of claim 19, wherein the composition is sprayed on an exterior surface or an interior surface.

22. The method of claim 19, wherein the exterior surface comprises a metal surface, a painted surface, a plastic surface, a rubber surface, or a glass surface.

23. The method of claim 19, wherein the exterior surface comprises the exterior surface of a vehicle; and optionally wherein the exterior surface comprises the surface of wheel, trim, chrome, hood, roof, door, or headlight.

24. The method of claim 19, wherein the composition further provides shine to the surface.
